(19) United States
(12) Patent Application Publication
(10) Pub. No.: US 2013/0002796 A1
(43) Pub. Date: Jan. 3, 2013

(54) System and Method For Incorporating Content In A Videoconferencing Environment Without A Personal Computer

(76) Inventors: William Everett Hiller, Austin, TX (US); Joseph Samuel, Chengannur (IN); Stephen Schaefer, Cedar Park, TX (US)

(21) Appl. No.: 13/537,237

(22) Filed: Jun. 29, 2012

Related U.S. Application Data
(60) Provisional application No. 61/502,642, filed on Jun. 29, 2011.

(51) Int. Cl. H04N 7/14

(52) U.S. Cl. 348/14.01; 348/E07.078

(57) ABSTRACT

A videoconference device provides an interface for initiating and controlling a videoconference and incorporating and annotating content in the videoconference without a personal computer. The content may reside on a portable storage medium such as a Universal Serial Bus (USB) or other flash memory device inserted in the interface device or on the device itself. The interface device may be a dedicated device for controlling the videoconferencing system, navigating to desired content, and interacting with the shared content. The device may also be a portable device such as a tablet device or mobile phone that interfaces with a videoconference system via an installed application.

### CROSS REFERENCE TO RELATED APPLICATIONS

This application claims priority to U.S. Provisional Application Ser. No. 61/502,642, entitled “System and Method for Incorporating Content in a Videoconferencing Environment Without a Personal Computer,” filed Jun. 29, 2011, the entire contents of which are incorporated herein by reference.

### FIELD OF THE DISCLOSURE

This disclosure relates generally to the field of videoconferencing. More particularly, but not by way of limitation, this disclosure relates to incorporating content in a videoconference without a personal computer.

### BACKGROUND

Videoconferencing systems have continued to increase in popularity due to their ever-expanding ability to provide rich interaction among participants who are geographically dispersed. Among the features that provide this rich interaction are high definition video, high quality audio, multipoint/multi-participant calls, and the ability to integrate additional content, such as presentation date, shared files, shared media content, etc.

Traditionally, sharing content during a videoconference has required a personal computer connected to a videoconferencing system. Conventional videoconferencing systems provide for a personal computer to be coupled via a VGA port or an Ethernet network connection to the videoconferencing system. In this manner, the personal computer display may be transmitted to remote videoconferencing locations such that participants at the remote locations can view the content displayed on the personal computer. Such an arrangement requires that conference participants bring a personal computer device such as a laptop to the conference location. Moreover, to transition to content stored on a different participant's personal computer device, a first device must be disconnected and the desired device connected while the videoconference continues. Furthermore, conventional videoconferencing systems, by broadcasting only a screen display of the connected personal computer, limit the ability of conference participants to interact with or call attention to certain portions of the shared content. Improvements to these interfaces are thus desirable.

### SUMMARY

Disclosed herein is a system and method for incorporating and annotating content in a videoconferencing environment without a personal computer. In one embodiment, the content may reside on a portable storage medium such as a Universal Serial Bus (USB) or other flash memory device and may be incorporated via insertion into a dedicated videoconference control device. The control device may be a touch panel that can provide a simplified and intuitive menu structure for controlling the videoconferencing system, navigating to desired content stored on the portable storage medium, and interacting with the shared content. In one embodiment, a device such as a tablet device or mobile phone may be utilized as a user interface to a videoconferencing system with content stored on a removable storage device or on the device itself incorporated into the videoconference via an application installed on the device that allows a user to browse for content stored on the device, incorporate the content in a videoconference, and interact with the shared content. Further aspects of the system and method for incorporating content in a videoconferencing environment are shown below.

### BRIEF DESCRIPTION OF THE DRAWINGS

FIG. 1 shows a block diagram of a videoconferencing system.

FIG. 2 shows a touch panel user interface that can implement a variety of the features described herein.

FIG. 3 shows a home screen for a user interface as described herein.

FIG. 4 shows a call screen for a user interface as described herein.

FIG. 5 shows a content screen for a user interface as described herein.

FIGS. 6-14 show various browse screens for a user interface as described herein.

FIG. 15 shows a preview mode file screen for a user interface as described herein.

FIGS. 16-18 show display mode file screens for a user interface as described herein.

FIG. 19 shows a content screen for a user interface while content is displayed in a videoconference as described herein.

FIG. 20 shows annotation capabilities of a user interface as described herein.

FIGS. 21-22 show various popup displays that may be displayed on a user interface as described herein.

### DETAILED DESCRIPTION

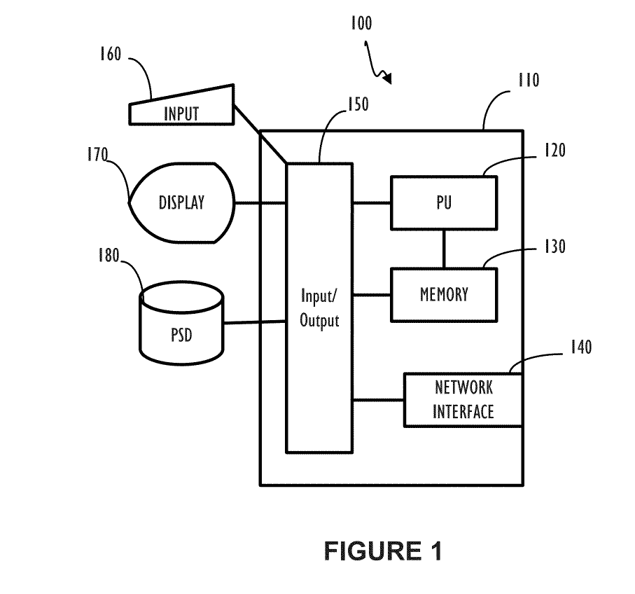

Referring now to FIG. 1, an exemplary conferencing device 100 is shown. Exemplary conferencing device 100 comprises a programmable control device 110 which may be optionally connected to input 160 (e.g., keyboard, mouse, touch screen, etc.), display 170 or program storage device (PSD) 180. Also, included with programmable control device 110 is a network interlace 140 for communication via a network with other conferencing and corporate infrastructure devices (not shown). Note network interface 140 may be included within programmable control device 110 or be external to programmable control device 110. In either case, programmable control device 110 will be communicatively coupled to network interface 140. Also note program storage unit 180 represents any form of non-volatile storage including, but not limited to, all forms of optical and magnetic storage elements including solid-state storage. Examples of conferencing device 100 include but are not limited to, personal computers, video conferencing endpoints, video conferencing data recorders, and MCUs.

Program control device 110 may be included in a conferencing device and be programmed to perform methods in accordance with this disclosure. Program control device 110 comprises a processor unit (PU) 120, input-output (I/O) interface 150 and memory 130. Processing unit 120 may include a microprocessor, a digital signal processor (DSP), an application-specific integrated circuit (ASIC), a field-programmable gate array (FPGA), or any other non-software programmable controller device including, for example, the Intel Core®, Pentium® and Celeron® processor families from Intel and the Cortex and ARM processor families from ARM. (INTEL CORE, PENTIUM and CELERON are registered trademarks of the Intel Corporation. CORTEX is a registered trademark of the ARM Limited Corporation. ARM is a registered trademark of the ARM Limited Company.) Memory 130 may include one or more memory modules and comprise random access memory (RAM), read only memory (ROM), programmable read only memory (PROM), programmable read-write memory, and solid state memory. One of ordinary skill in the art will also recognize that PU 120 may also include some internal memory including, for example, cache memory.

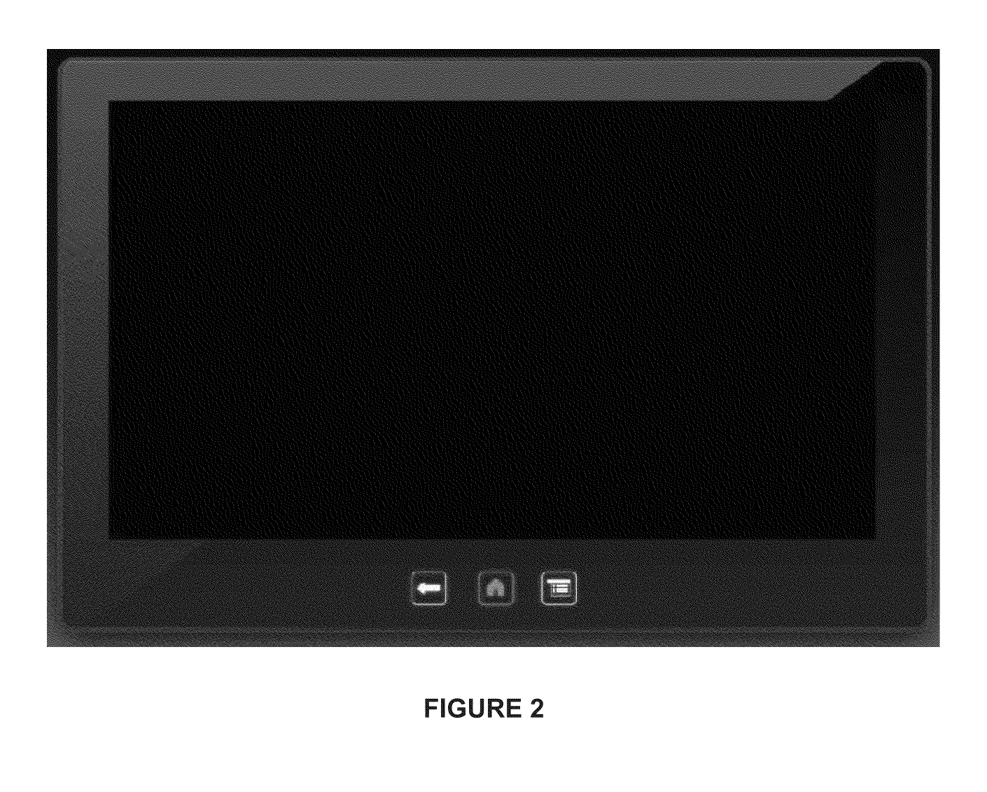

Illustrated in FIG. 2 is an embodiment of a user interface device incorporating various features of the present invention. The user interface device may include some or all of the components described above with respect to conferencing device 100. The user interface can interface to an appropriate input on the conferencing device 100, such as a standard I/O port (Ethernet, USB, IEEE 1394, RS-232, IEEE 1284, etc.) or a proprietary interface. The user interlace can also interface wirelessly, using Bluetooth, IR, WiFi, etc. While various features of the present invention will generally be described with reference to a dedicated videoconferencing control device, it will be understood that the user interface device may also be a tablet device, mobile phone, or any other non-personal computer device capable of performing the functions described herein.

The user interface can also include a touch screen, including a screen portion, a surrounding bezel, and one or more buttons. The touch screen can be based on any of a variety of known touch sensing technologies, including capacitive, resistive, surface acoustic wave, frustrated total internal reflection, etc. The touch screen may be implemented as a single-touch screen, in which only one contact point can be detected and tracked at any one time or can be implemented as a multi-touch screen, in which multiple contact points can be detected and tracked. As will be appreciated by those skilled in the art, a multi-touch screen allows the use of more complex interactions such as multi-finger gestures, further enhancing the functionality of the touch screen.

The user interface device may also include one or more buttons of a variety of types, including momentary contact push buttons, virtual keys or touch-sensitive regions on the bezel based on resistive, capacitive, or other touch sensing technologies, or other types of button-like interfaces known to those skilled in the art. In the illustrated embodiment, three buttons are provided, a home button, a back button, and an information/settings button. While the number of buttons provided in the illustrated embodiment is believed to be particularly desirable from a user interface design perspective, in various embodiments, more or fewer buttons could also be provided as desired.

The home button can be used for accessing or returning to the primary interface screen or “home menu.” The back button can be used for returning to the previously displayed screen, which can be a higher level menu or interface screen, a lower level menu or interface screen, or a different page of the current menu level. Finally, the information/lsettings button can be provided for accessing other menus or settings as will be described below.

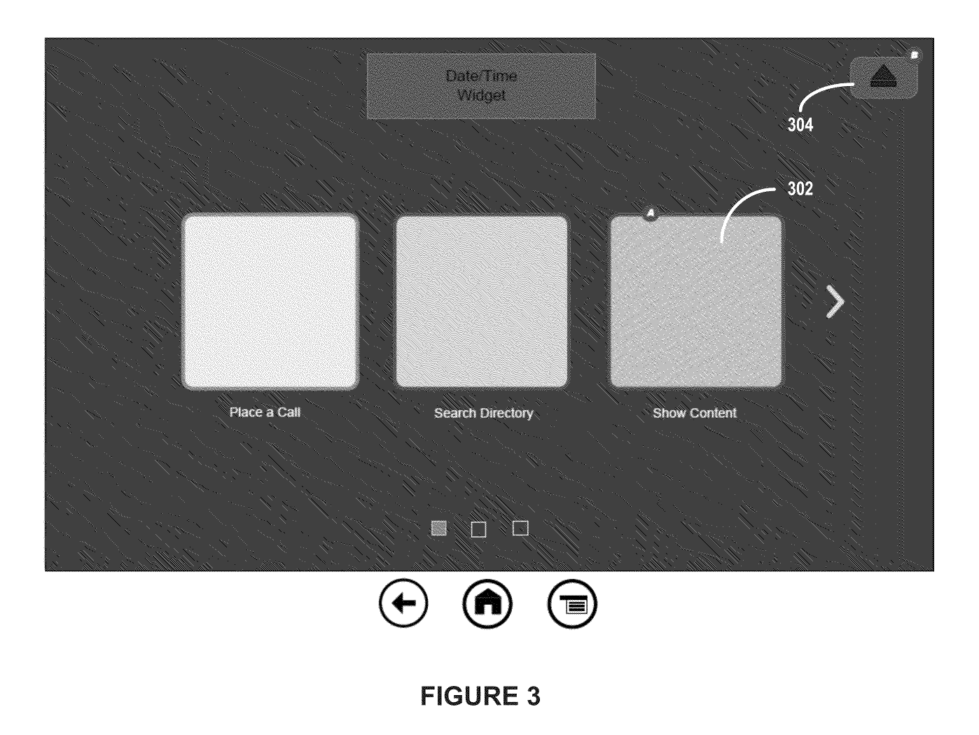

Referring to FIG. 3, a home screen of the user interface is illustrated. In one embodiment this screen may be utilized for launching content while a videoconference call is not currently active. The home screen may represent the primary interface with a videoconferencing system not in an active call. For example, the home screen may display a date and time such that a user can determine an appropriate time to join a scheduled videoconference. The home screen may additionally provide functionality for placing a call and/or searching through a directory of remote videoconference locations to select a location to initiate a call.

From the home screen, a user may select a content icon 302 to activate content control. As will be described below, selecting the content icon 302 may take the user to a content screen that displays connected storage devices to allow the user to select a desired device. For example, the content screen may display connected USB memory devices. In one embodiment, inserting a storage device may cause an eject icon 304 to appear on the home screen. The eject icon 304 may be selected by a user to properly remove a storage device from the user interface, such as without the risk of flash memory corruption. In one embodiment, selecting eject icon 304 may take the user to a screen displaying connected storage devices to allow the user to select the particular device to be removed. In one embodiment, inserting a storage device while the home screen of the user interface is displayed may cause the user interface to automatically display the content screen without the requirement that a user select content icon 302. If content is stored directly on the user interface rather than on a removable storage device, the content icon 302 may bypass the content screen and take a user directly to a browse screen as will be described below.

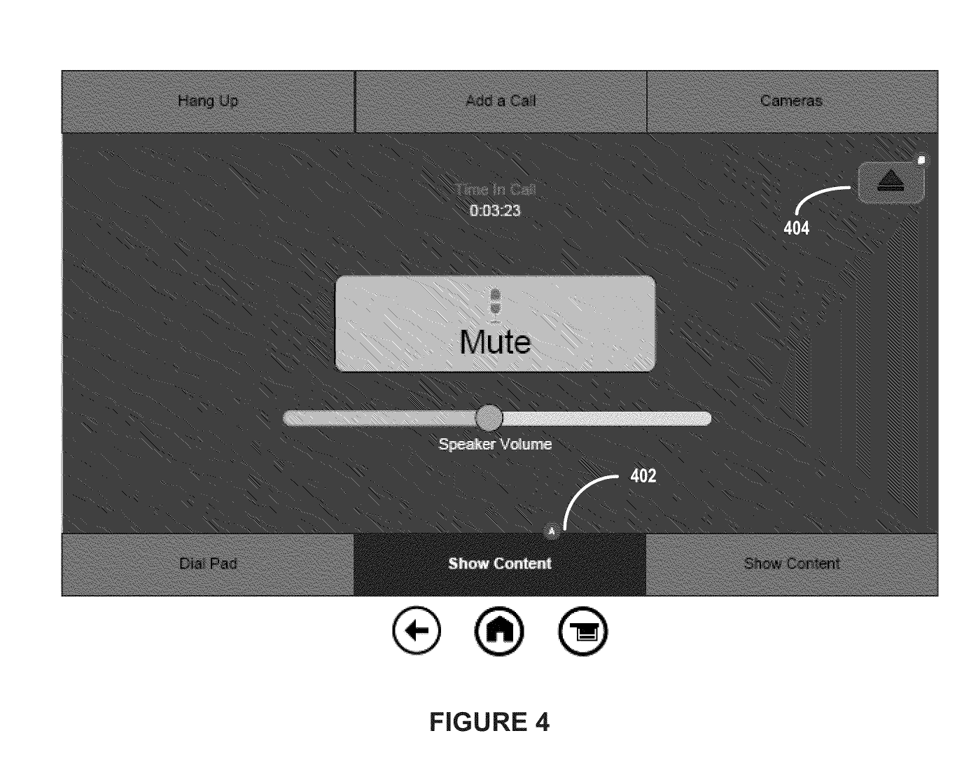

Referring to FIG. 4, a call screen of the user interface is illustrated. In one embodiment this screen may be utilized for launching content while a videoconference call is currently active. The call screen may represent a primary interface with a videoconferencing system in an active call and may provide information and functionality relevant to an ongoing videoconference call. For example, the call screen may provide information related to the duration of an ongoing videoconference call as well as functionality for terminating a call, adding a call participant, and adjusting settings at the local videoconference location such as speaker volume and camera settings.

The call screen may provide similar functionality to the home screen with respect to launching content. From the call screen, a user may select a content icon 402 to activate content control, Like the content icon of the home screen, selecting the content icon 402 from the call screen may take the user to the content screen. If content is being displayed during an ongoing videoconference call, however, the content icon 402 may display “Stop Content”. Selecting the content icon 402 in this mode may stop the display of content in the videoconference and take the user to the content screen. In one embodiment, when a storage device is inserted in the user interface an eject icon 404 may be displayed on the call screen in a similar manner as on the home screen to allow a user to browse connected devices and select a device for removal. In one embodiment, automatic navigation to the content screen upon the insertion of a removable storage device, as described above with reference to the home screen, may be configurable such that insertion of a storage device may or may not cause the user interface to browse to a different screen. This functionality may be particularly desirable with respect to the call screen as a user may prefer to maintain control of the call from the call screen and browse to the content screen upon demand.

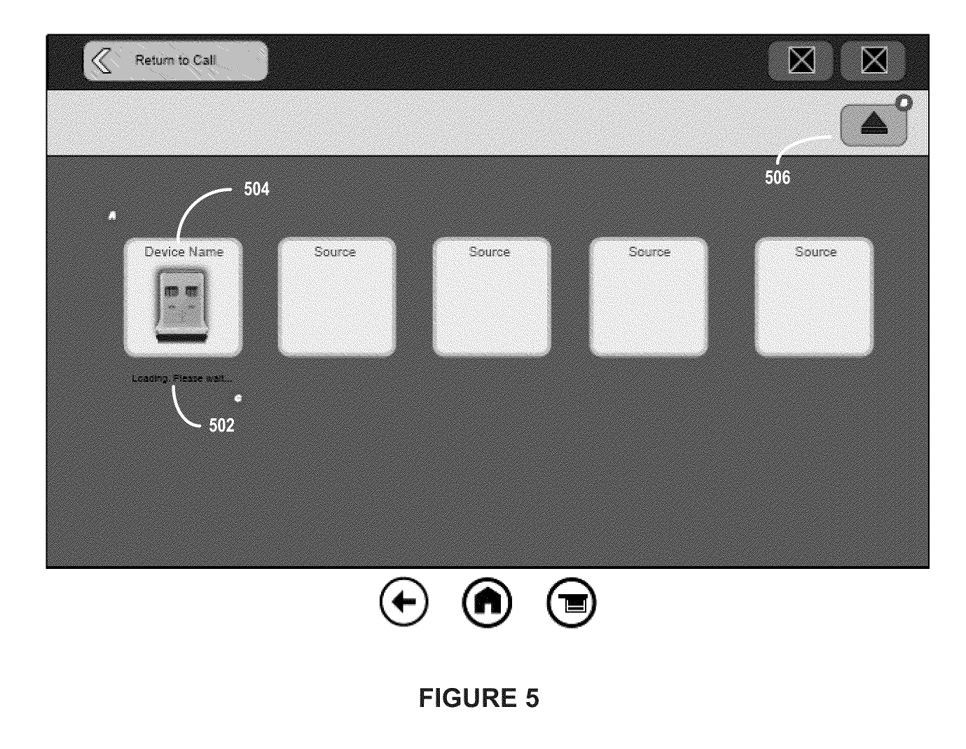

Selecting the content icon from either the home screen or call screen may cause the user interface to display the content screen illustrated in FIG. 5. The content screen may display one or more storage devices connected to the user interface. When a removable storage device is inserted in the user interface, the user interface may immediately begin to index the contents of the storage device. As the user interface indexes the contents of the connected storage device, it may gather information pertaining to file names, file types, file sizes, file modification dates, recently viewed files, and file structures of the storage device such that the contents of the storage device may be displayed and searched according to the file structure of the storage device. As the user interface indexes a connected storage device, the progress 502 of the indexing operation may be displayed as a percentage near the connected storage device icon 504. The user interface may identify subsequent connections of a previously connected storage device and may search only for changes in the storage device in order to increase the efficiency of the indexing operation.

The storage device icon 504 may be selected before the indexing operation is complete, however, only those files that have been indexed may be displayed. As additional files are indexed they may become available without the need to refresh the display. Selecting the storage device icon 504 when content is not currently selected may take the user to a browse view as described in detail below. If content is currently being displayed in a videoconference, the storage device icon may display a file type icon or screen display of the selected content rather than a connected device icon, Selecting the device icon 504 when content is currently selected may take the user to a file view as described below. An eject icon 506 may be utilized to safely remove a device from the content screen.

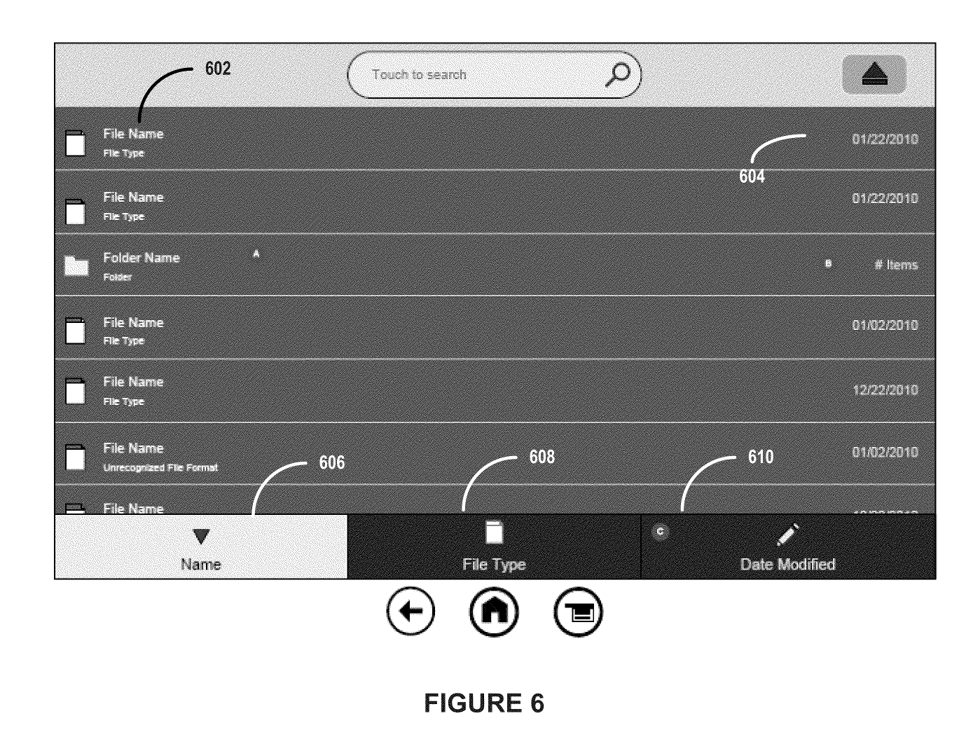

Selecting the storage device icon when content is not currently selected may display a main folder (i.e., root directory) browse view of the connected storage device as depicted in FIG. 6. A file list 602 may display information about the files and folders stored in the main folder of the selected storage device. The file list may display a thumbnail along with a file name and file type for each recognized file. Similarly, a folder icon and folder name may be displayed for each of the subfolders in the main folder browse view of the device. File list 602 may additionally indicate that certain files in the displayed directory are of an unrecognizable format.

For each file and folder in the directory, a modification date indicating the most recent date on which the file was modified may be displayed in a date modified list 604. For folders in the directory, the date modified list may indicate the number of items in the folder rather than a modification date. For example, each file or subfolder in the displayed folder may be counted as an item in the folder.

The files and folders in a browse view may be sorted by file name, file type, or modification date. Selecting one of the sort icons (file name 606, file type 608, or modification date 610) may sort the files and subfolders of the displayed directory according to the selected method. Selecting one of the sort icons may also cause the selected icon to be highlighted such that the user can quickly determine the sort method that is applied to the displayed directory. The highlighted sort icon may additionally indicate a sort order (i.e. ascending or descending) by displaying a carrot within the sort icon. Selecting the same sort icon again may change the sort order. In one embodiment, when a folder is displayed, a default sort (e.g., ascending by file name) may be applied. In another embodiment, a sort order for a particular folder may be maintained such that when a user browses back to a previously viewed folder the same sort order may be applied.

In one embodiment, a scrollbar may be displayed on a side of the browse screen to allow navigation of the files and folders in the displayed directory. In another embodiment, navigation may be accomplished through the use of touch gestures, such as a swipe, flick, drag, or slide gesture using a pre-determined number of fingers. In one embodiment, as a user utilizes touch gestures to scroll through the directory, scrolling may become faster. For example, after a user has used two touch gestures indicative of a desire to scroll through the directory, subsequent gestures may result in scrolling through the directory more quickly. In another embodiment, a letter (in the case of file name or file type sorting) or a date (in the case of modification date sorting) may be displayed prominently on the screen as the user scrolls through the directory to make the user aware of the current position within the directory.

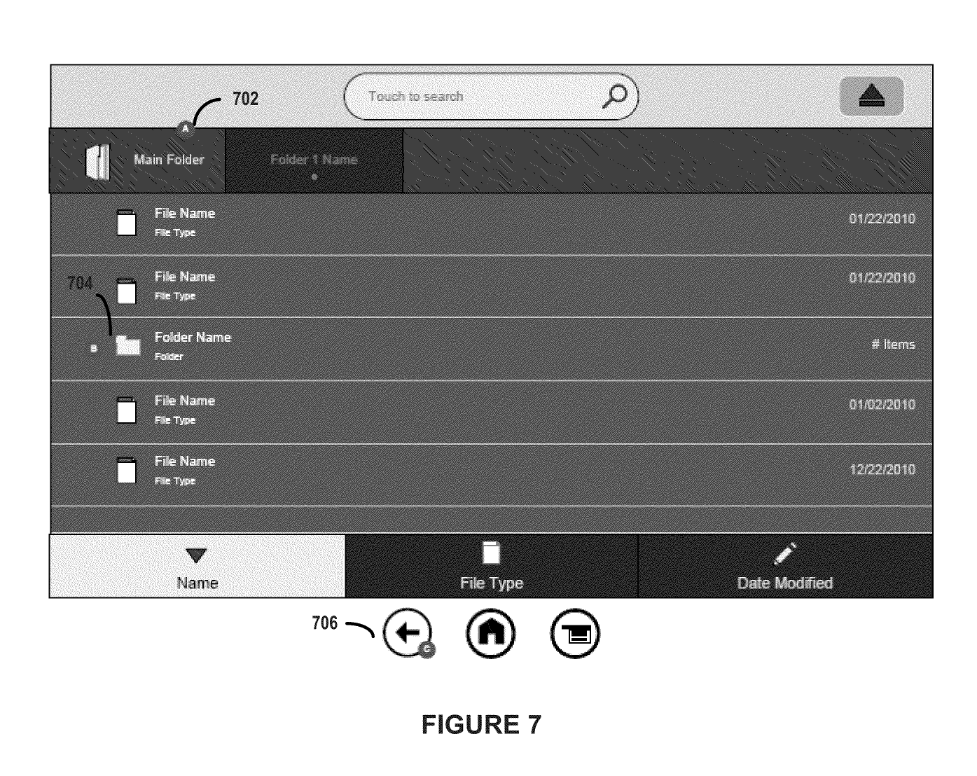

Selecting a folder from the file list of the main folder browse view may display the contents of the folder as illustrated in FIG. 7. The contents of the folder may be sorted and navigated in the same manner as in the main folder browse view. In addition to the features of the main folder browse view, when the user navigates away from the main folder of the storage device, the user interface may display a breadcrumbs list 702. Breadcrumbs list 702 is a last in first out data structure that represents a navigation stack. As a user drills down in the folder tree, folders are added to the stack. In one embodiment, the main folder may be displayed at the left of the breadcrumbs list 702 while the currently active folder may be displayed at the right of the breadcrumbs list 702. Accordingly, breadcrumbs list 702 may provide a hierarchical representation of the current location within the file structure of the storage device by maintaining and displaying the folder name for each level that the user selects. In one embodiment, file list 704 may be indented once the user navigates away from the main folder view to quickly indicate that the user has navigated away from the main folder, in one embodiment, back button 706 may be used to display the last previously viewed screen. If the user sequentially drills down in the folder tree, back button 706 will display the contents of the folder in which the currently active folder resides (i.e., one level up in the folder tree), however, because each of the folder names in the breadcrumbs list 702 may be selected to display the contents of that folder, if the user skips between folders using breadcrumbs list 702, back button 706 will display the preceding display rather than the preceding level in the folder tree. Navigating via, breadcrumbs list 702 may be particularly useful when a user wants to return to a folder several levels up in the folder tree from the currently active folder. Rather than using the back button to retreat one level at a time, the user may directly select the desired folder from the breadcrumbs list 702.

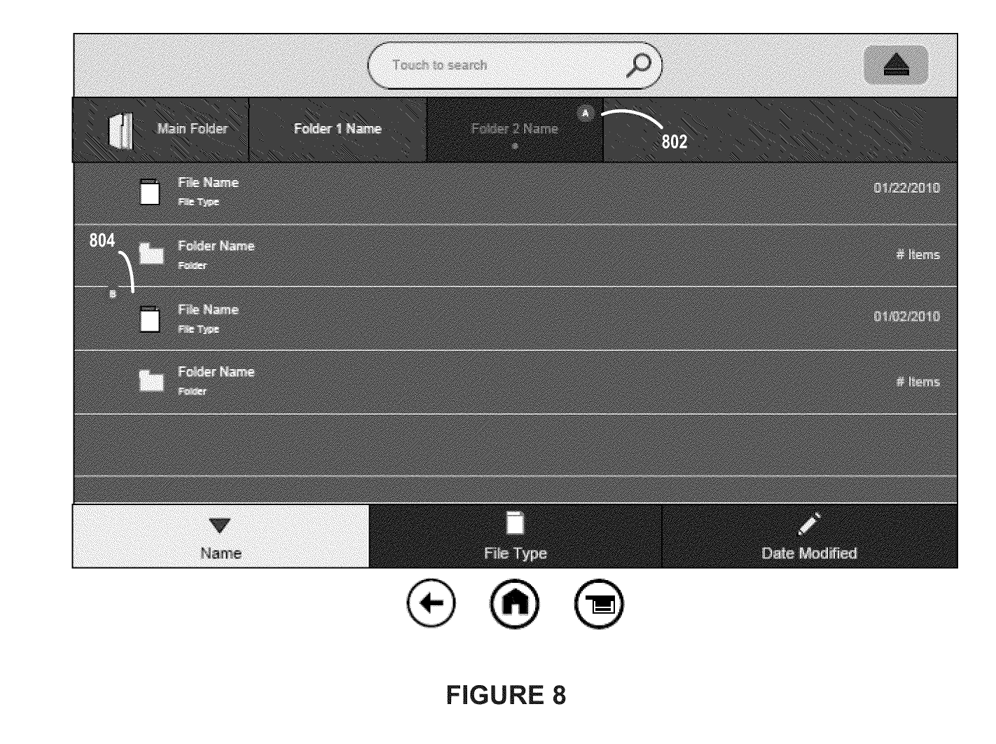

As depicted in FIG. 8, as the user drills down in the folder tree, breadcrumbs list 802 is updated to show the hierarchical location of the currently active folder in the folder tree. In one embodiment, file list 804 may not be further indented as the user drills down further in the folder tree. Accordingly, an indented file list 804 may allow the user to quickly determine that the displayed folder is not the root folder without further sacrificing screen display space by further indenting file list 804 for each subsequent level in the folder tree.

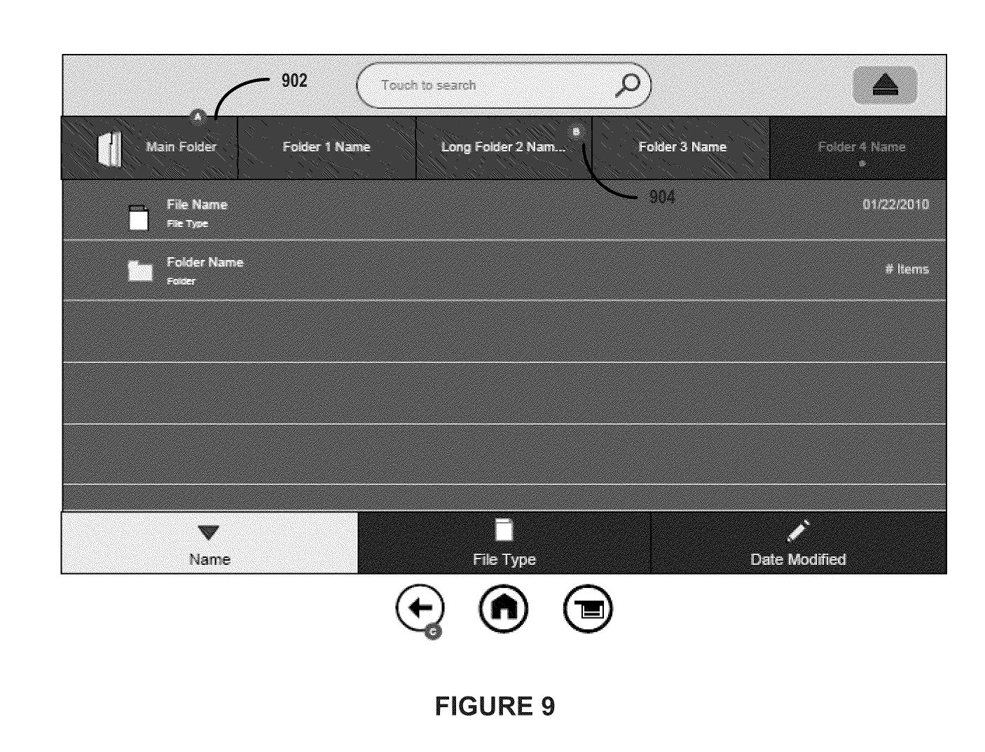

As depicted in the embodiment shown in FIG. 9, each of the folders 902 in the breadcrumbs list may be displayed as the same size regardless of the length of the folder name or the number of folders in the breadcrumbs list. For example, the text of a folder having a lengthy name 904 may be truncated in order to provide a consistent display. Because the full folder name is displayed in the file list, a user will be able to recognize the truncated name having selected the folder from a file list in a browse view.

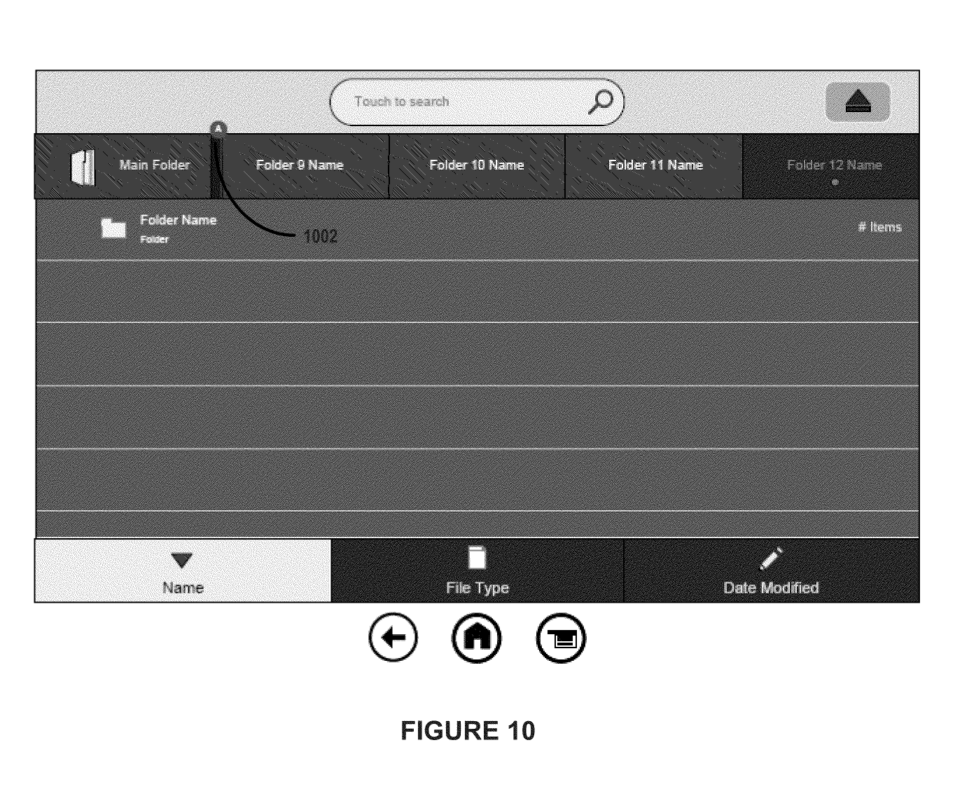

As illustrated in FIG. 10, when the display of folders in the breadcrumbs list becomes saturated (e.g., more than five levels deep in the folder tree), folders beneath the main folder in the folder tree are successively hidden 1002 as a new folder is selected. In one embodiment, the main folder may always be displayed in the breadcrumbs list in order to allow the user to retreat to the main folder of the storage device regardless of the currently active folder.

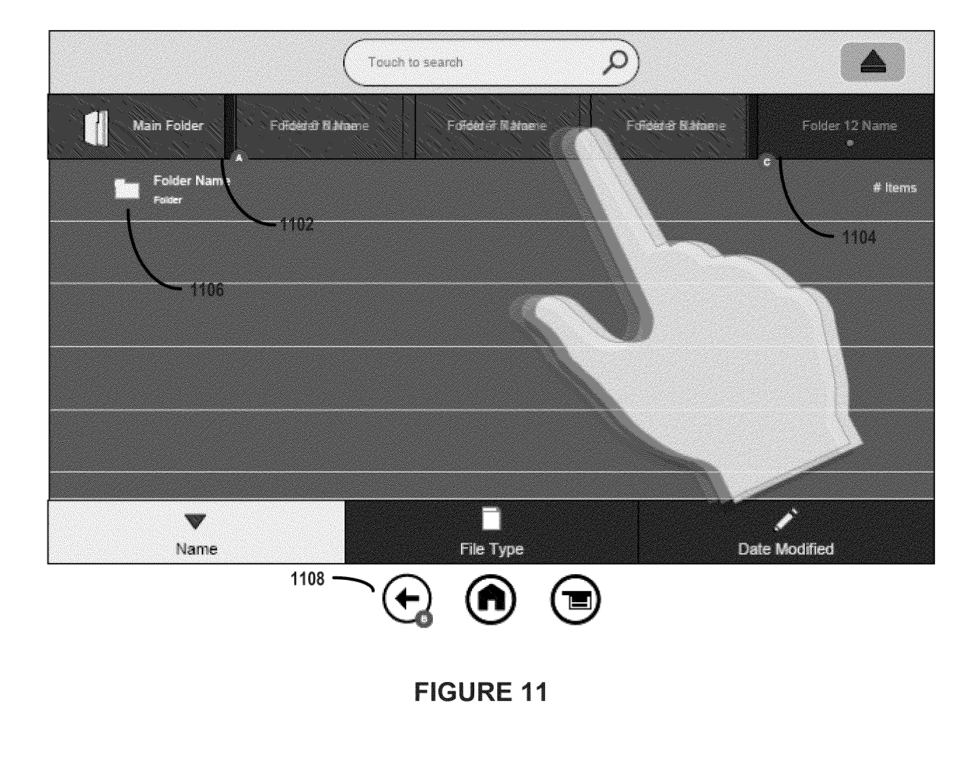

When folders in the breadcrumbs list are hidden in this manner, the user may browse the folders of the breadcrumbs list using touch gestures similar to those used to navigate the file list as depicted in FIG. 11, in the depicted embodiment, only those folders between the main folder 1102 and the currently displayed folder 1104 may be scrolled. The user will therefore be aware that the files and folders displayed in the file list 1106 belong to the currently active folder 1104 even while scrolling through the breadcrumb list. Navigating away from the currently active folder 1104 using either the breadcrumb list or back button 1108 will cause the breadcrumb list display to be immediately updated. Subfolders of a selected folder will no longer be displayed in the breadcrumb list and the selected folder will be shown as the currently active folder at the right of the breadcrumb list.

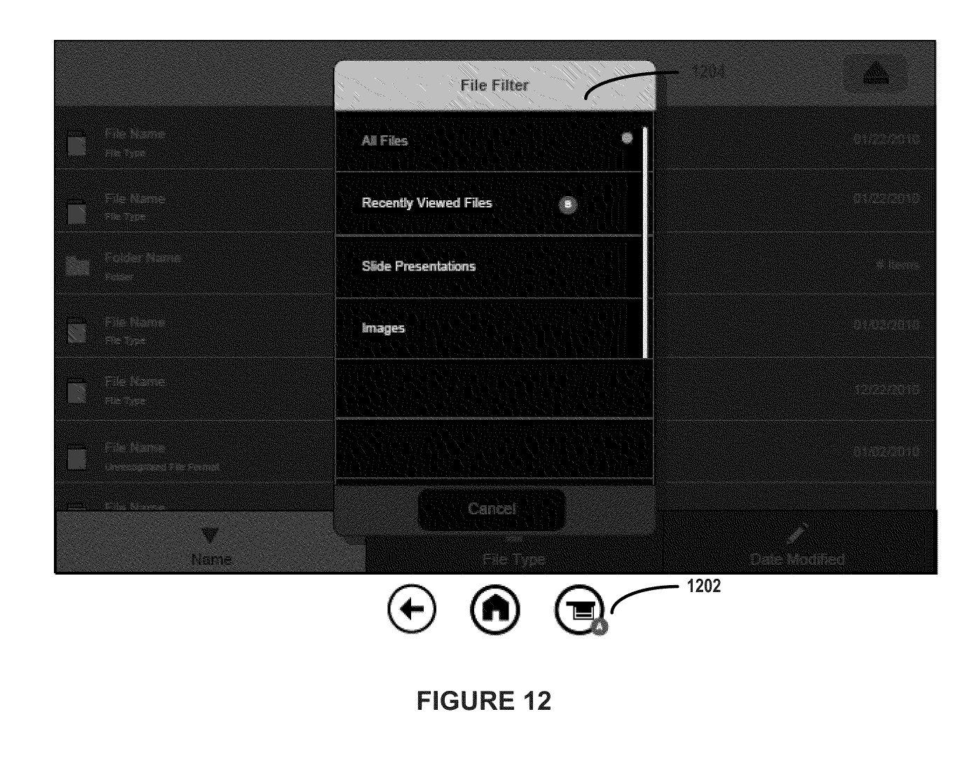

Referring to FIG. 12, the contents of a connected storage device may additionally be browsed by selecting menu button 1202. Selecting menu button 1202 may cause file filter 1204 to be displayed. From file filter 1204, a user may select to view all content of a certain type such as slideshows, images, word processing files, spreadsheets, etc. stored on the connected storage device. Selecting one of these options may cause the user interface to query the index of the connected storage device to return a list of all content having characteristics of the selected type. In one embodiment, this may be accomplished by searching filename extensions of the files stored on the storage device. For example, selecting images from file filter 1204 may cause the user interface to return a list of all files on the connected storage device having .jpeg, .bmp, .gif, etc. file extensions. The user interface may perform a similar operation for other types of content selected from file filter 1204.

In addition, a user may select to view recently viewed files from file filter 1204. In one embodiment, a file of a connected storage device selected for display may be marked as having been displayed in a videoconference such that the file may subsequently be recognized by the same or any other device as having previously been displayed in a videoconference.

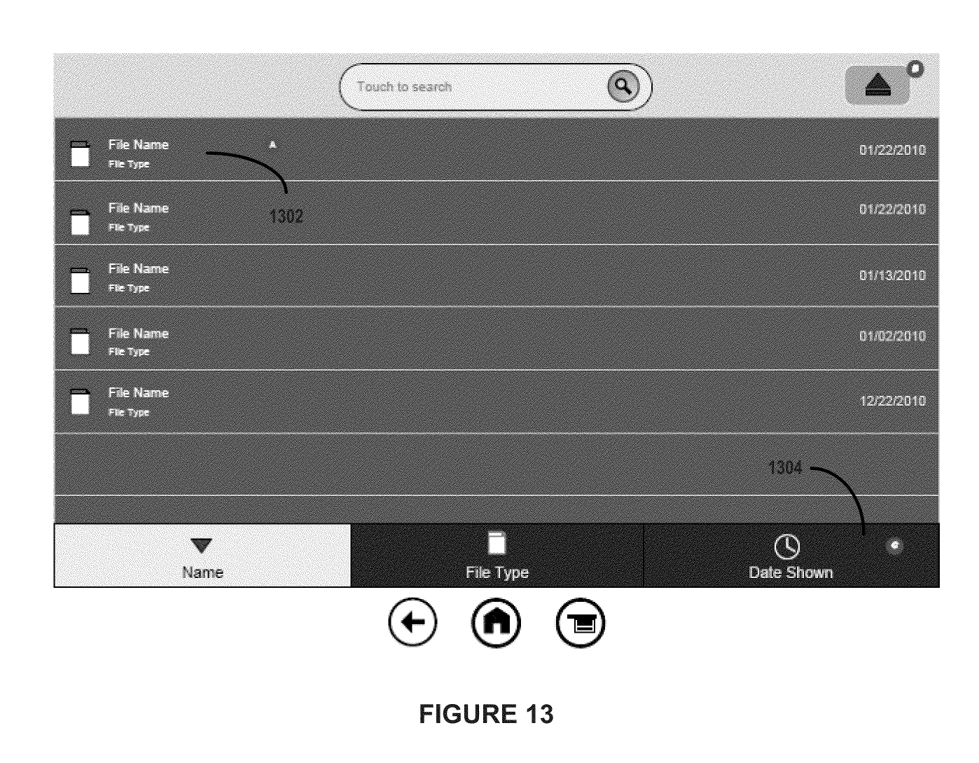

Selecting to display recently viewed files from file filter 1204 may result in a list of recently viewed files 1302 being displayed as depicted in FIG. 13. If no files of the connected storage device have been marked as previously displayed as part of a videoconference, file filter 1204 may not provide an option to display recently viewed files. In one embodiment, the default sort for the recently viewed files screen may be the date shown 1304 in a videoconference such that the content most recently viewed appears at the top of the list.

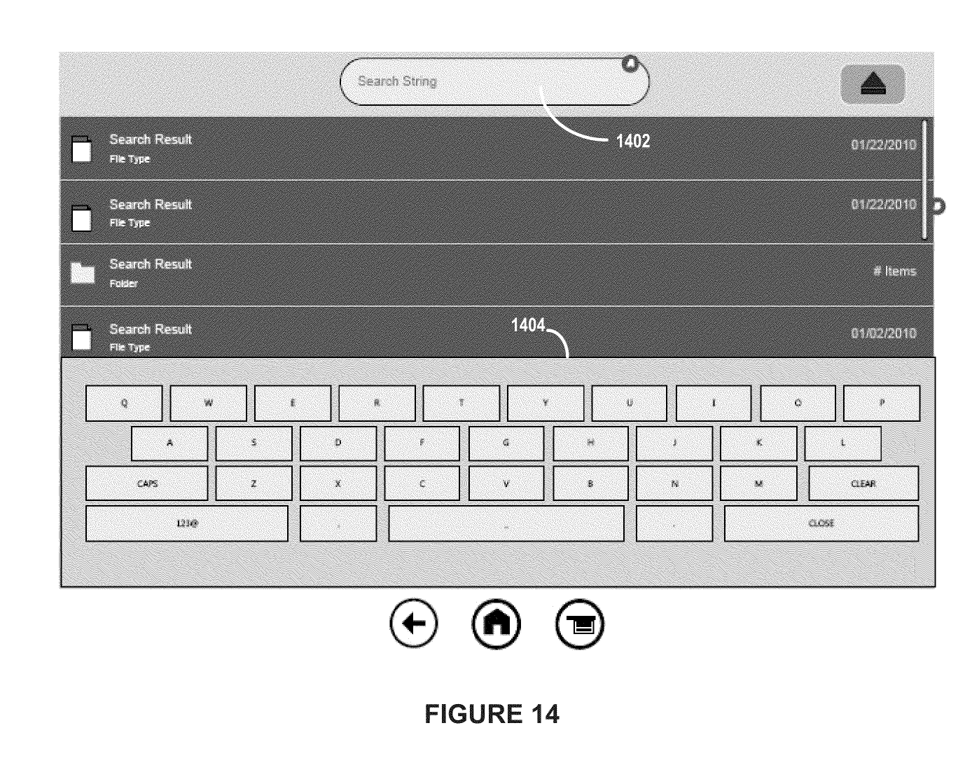

Referring to FIG. 14, a user may select to search for a file or folder name by entering a search term in search box 1402 from a browse view at any level. In one embodiment, selecting search box 1402 may result in a virtual keyboard 1404 being displayed on the screen to enable search term entry. Alternatively, a connected keyboard device may be used to enter search terms. In one embodiment, a list of files and folders matching the search term will be updated as each additional character is added to the search term. In one embodiment, a search may return only those results matching the search term and located within the currently active folder or a subfolder of the currently active folder. Accordingly, a user may search all files and folders of the connected storage device by entering a search term while the main folder is the currently active folder.

When a user locates the particular file that they wish to incorporate as content in a videoconference, the file can be selected from the list. In one embodiment, selecting a file from the list of files may cause the file to be rendered in a way in which it can be displayed as content in a videoconference. By opening files in a viewable rather than editable manner, a user interface may support the incorporation of content from a wide variety of file types without maintaining the software required to edit the supported file types on the user interface.

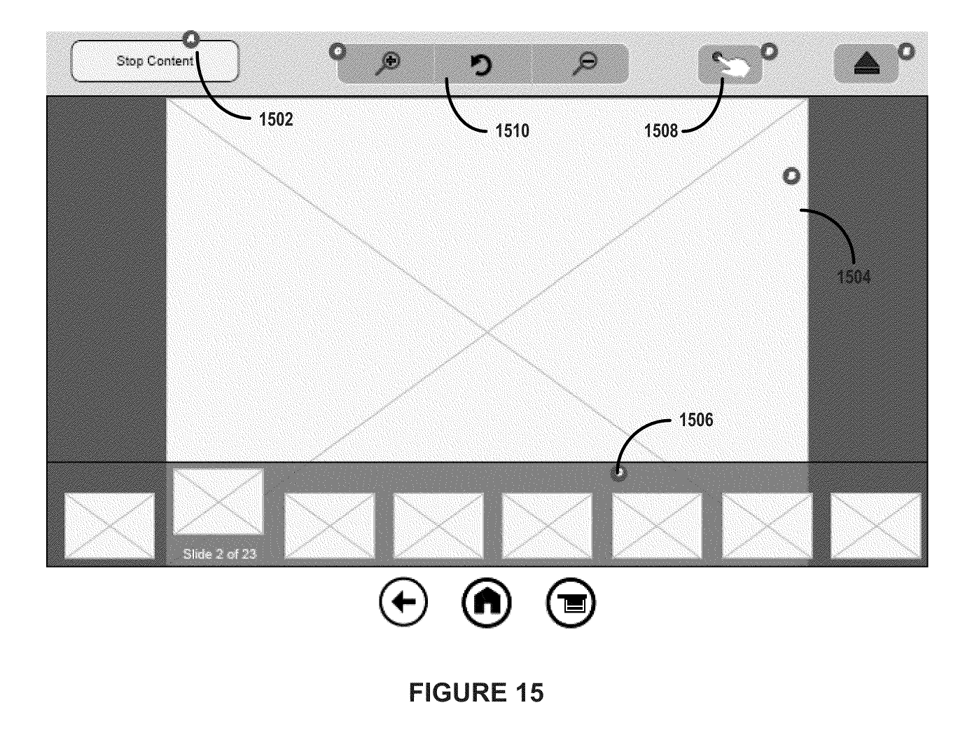

Referring to FIG. 15, an example slideshow is illustrated. In one embodiment, when a file is selected it may initially be displayed only on the user interface. Prior to incorporating the content in a videoconference by selecting display icon 1502, the file may be viewed in preview mode. In preview mode a selected slide 1504 may be shown in the main portion of the user interface while each of the slides in the slideshow may be displayed and selectable in a preview bar 1506. The preview bar 1506 may be scrollable using touch gestures as described above. Selecting a slide from the preview bar 1506 may cause the selected slide to be displayed in the main portion of the user interface. As will be described in further detail below, a user may also annotate slides by selecting annotation icon 1508. Therefore, preview mode may allow a user to review a file on the user interface before the content is displayed at either a local videoconference location or any remote videoconference location. The user may also select portions of a slideshow that should be annotated prior to displaying the content. For example, a user may redact unwanted portions or highlight desired portions of a slideshow prior to displaying the content as described below. In one embodiment, zoom icon 1510 may be utilized by a user in order to zoom in or out on the selected slide. Zoom icon 1510 may enable a user to focus on or make annotations on a portion of the selected slide. Selecting the refresh icon located between the zoom in and zoom out icons of the zoom icon 1510 may return to a full screen view of the selected slide. When content is being actively displayed in a videoconference, display icon 1502 may display “Stop Content” and may be selected to return to preview mode in which the file is visible only on the user interface.

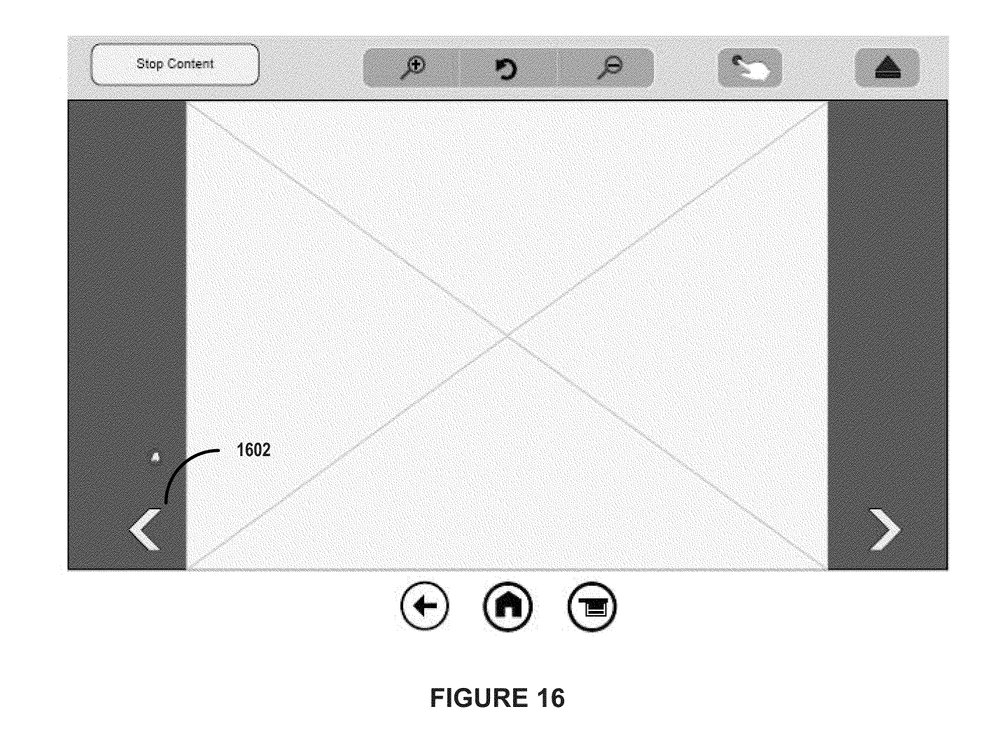

When a user selects the display icon 1502, the user interface transitions from preview mode to display mode as illustrated in FIG. 16. In the depicted embodiment, the selected slide is displayed on the user interface and the user can advance to previous or subsequent slides using arrows 1602. In one embodiment, the slide selected in preview mode when the user selects the show content icon may be the initial slide displayed as content in the videoconference. In another embodiment, when the user selects the show content icon, the user interface may select the first slide of the slideshow to display as content in the videoconference by default. In one embodiment, each of the slides in the slideshow may be displayed on the user interface in display mode in a similar arrangement as in the preview bar of preview mode. While only the selected slide may be displayed as content in the videoconference, such an arrangement may allow a user to advance to a desired slide without advancing through each slide between the selected slide and the desired slide.

When a user selects to display certain content in a videoconference (i.e., by selecting display icon 1502), the user interface begins transmitting data representing the content to conferencing device 100 as described in FIG. 1. In one embodiment, the user interface may be pre-configured with an Internet protocol address of a particular conferencing device 100 in order to transmit the data to the proper device. In one embodiment, the content may be transmitted as an image that may be displayed as a live graphic at local and remote videoconference locations. In one embodiment, the image may be compressed and scaled by the user interface. In an alternate embodiment, however, processing of the image may be performed by conferencing device 100 (i.e. conferencing device 100 may provide compression, mixing, and scaling operations). As described above with respect to FIG. 2, in one embodiment data may be transmitted from the user interface to an appropriate input on the videoconferencing unit, such as a standard I/O port (Ethernet, USB, IEEE 1394, RS-232, IEEE 1284, etc.) or a proprietary interface. In another embodiment, data may be wirelessly transmitted to the videoconferencing unit using Bluetooth, WiFi, IR, etc.

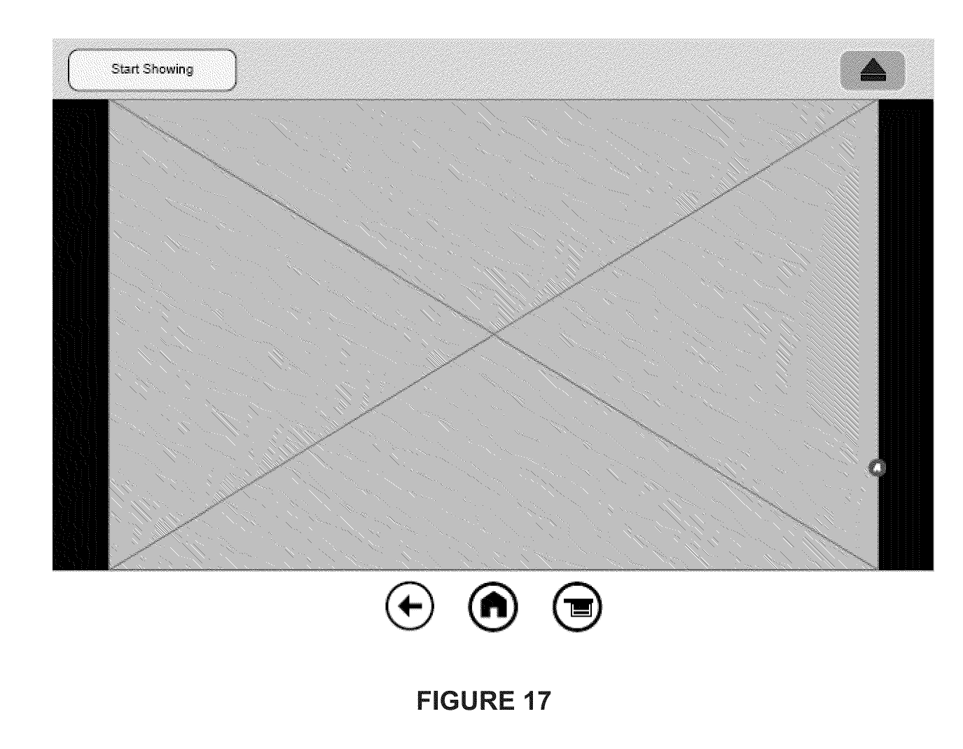

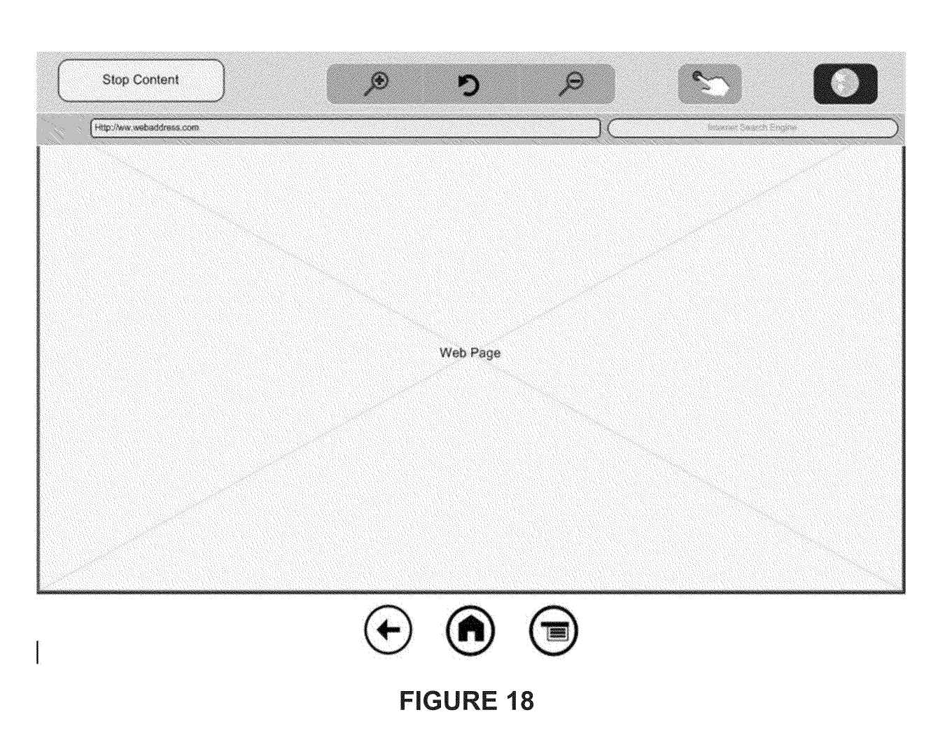

Referring to FIG. 17 and FIG. 18, an image file and a webpage are respectively illustrated as content selected to be displayed in a videoconference. Like the slideshow illustrated in FIG. 15 and FIG. 16, the image file and webpage may initially be displayed in preview mode in which they are displayed only on the user interface, Only when the user selects the display icon will the selected content be transmitted to the conferencing device to be displayed in the videoconference. Also like the slideshow, the image file and webpage may be annotated both prior to displaying the content in the videoconference or while the content is being displayed in the videoconference as described below. The image file may be selected, for example, by browsing either a local directory of the user interface or a storage device inserted in the user interface as described above. The website illustrated in FIG. 18 may be selected by browsing to a live website, for example via a built-in browser of the user interface. In one embodiment, the content screen depicted in FIG. 5, in addition to displaying connected storage devices, may indicate an available Internet connection that, when selected, may activate a built-in browser of the user interface to allow the user to browse to a desired Internet website.

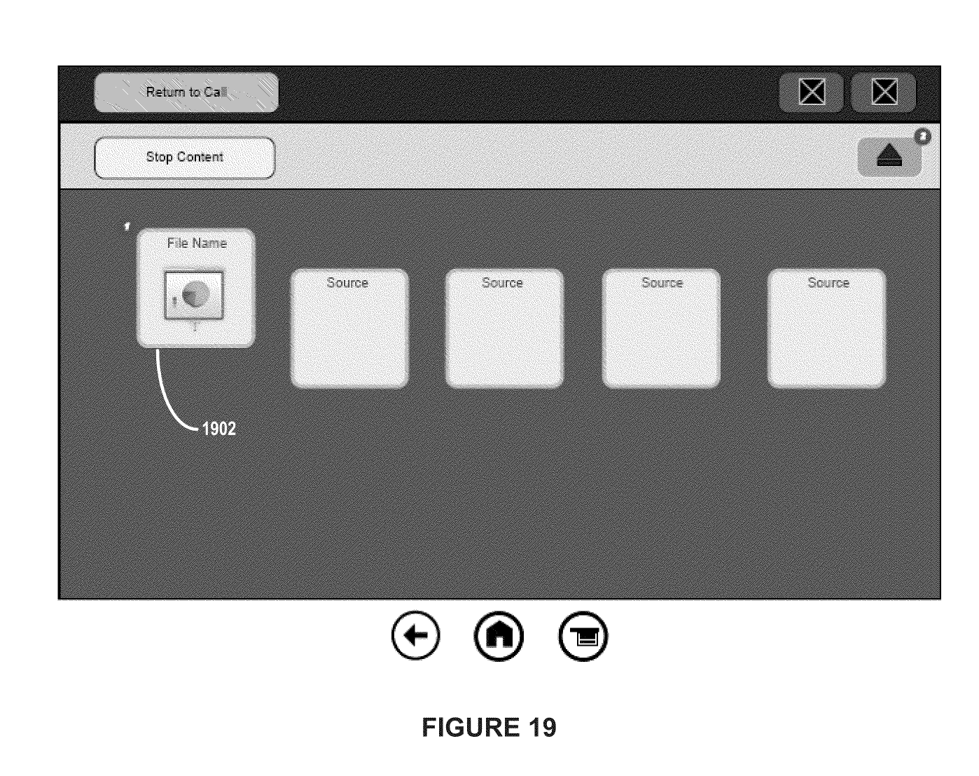

Referring to FIG. 19, when content is being displayed in a videoconference, the storage device icon 1902 may display a file name and a file type icon or screen display of the selected content rather than a connected device icon. In one embodiment, the connected storage device on which the content that is being displayed is stored may be elevated with respect to other connected storage devices or content sources. Selecting storage device icon 1902 in this mode may take the user directly to the file view (in either preview or display mode) for the selected content rather than to a browse view of the device.

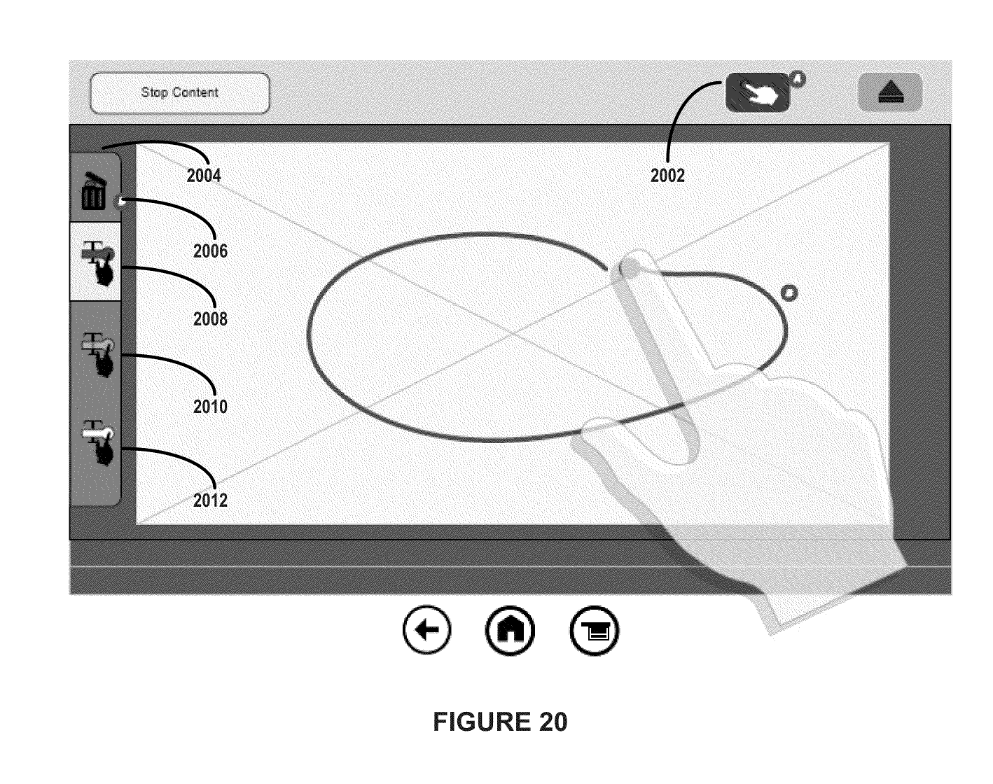

As described briefly above, a user may annotate content in either preview or display mode such as by selecting annotation icon 2002 as depicted in FIG. 20. Selecting annotation icon 2002 may cause the user interface to display annotation toolbar 2004. When annotations are active, such as when annotation icon 2002 has been selected and annotation toolbar 2004 is displayed, a user may make annotations to the content displayed on the user interface. In one embodiment, content may be annotated by selecting an annotation tool from annotation toolbar 2004 and subsequently using touch gestures on the content displayed on the user interface to make the desired annotations.

In one embodiment, annotation toolbar 2004 may contain a laser pointer tool 2008, a highlighter tool 2010, a white out tool 2012, and a remove annotations tool 2006. In one embodiment, laser pointer tool 2008 may be selected by default. For example, selecting annotation icon 2002 may display annotation toolbar 2004 with laser pointer tool 2008 active. In one embodiment, the laser pointer tool 2008 may mimic an actual laser pointer and cause an annotation to be overlaid on the displayed content only while a user is touching a portion of the displayed content on the user interface that the user wishes to call attention to. In another embodiment, the laser pointer tool 2008 may be used to make notes and/or call attention to a particular portion of the displayed content by leaving a trail indicative of a touch gesture executed on the displayed content on the user interface by a user. The highlighter tool 2010 may overlay a transparent color on the displayed content while allowing the displayed content to be seen through the annotation to call attention to a particular portion of the content such as text. The white out tool 2012 may be used to make certain portions of selected content invisible at the local and remote videoconference displays by overlaying a non-transparent markup on the content. In one embodiment, properties of the various annotation tools (e.g., color and line width) may be modified by selecting an annotation menu. In another embodiment, properties of the annotation tools may be based on the interaction with the user interface. For example, applying more pressure to a touch screen display may result in a larger line width. If content is being displayed in a videoconference, annotations made on the user interface will be transmitted to the conferencing device and displayed at local and remote conference locations as they are made. As described above, however, annotations may also be made in preview mode prior to displaying content in a videoconference.

In one embodiment, annotations may remain until the user selects remove annotations tool 2006. In one embodiment, annotations may be hidden by selecting annotation icon 2002. When annotations are hidden, the user interface (and the conference displays if content is being displayed in a videoconference) may display the content without annotations. Subsequently selecting annotation icon 2002, however, may cause the previous annotations to be displayed if the annotations have not been deleted by selecting remove annotations tool 2006. In one embodiment, remove annotations tool 2006 may cause all annotations to be deleted (e.g., annotations for each slide in a slideshow). In another embodiment, remove annotations tool 2006 may delete only the annotations for the content displayed on the user interface (e.g., for the selected slide in a slideshow). In one embodiment, annotations may be saved to the removable storage device on which the content is stored or to a local memory of the user interface. In one embodiment, annotations may be saved automatically, such as when a user selects to stop displaying content in a videoconference. This may allow a meeting organizer to transmit annotated content from a videoconference to conference participants, such as by attaching the annotated content file from the videoconference to an email with the meeting minutes. In one embodiment, a user may be prompted to select a desired file type according to which the annotated content may be saved. For example annotated content may be saved as an image file, a portable document file (.pdf), or any other desired file format. Depending on the file type, annotations may be saved in a separate layer from the original content. In one embodiment, selecting a previously displayed file in a subsequent videoconference, such as by searching for and selecting a recently viewed file as described above, may cause the previously annotated content to be displayed.

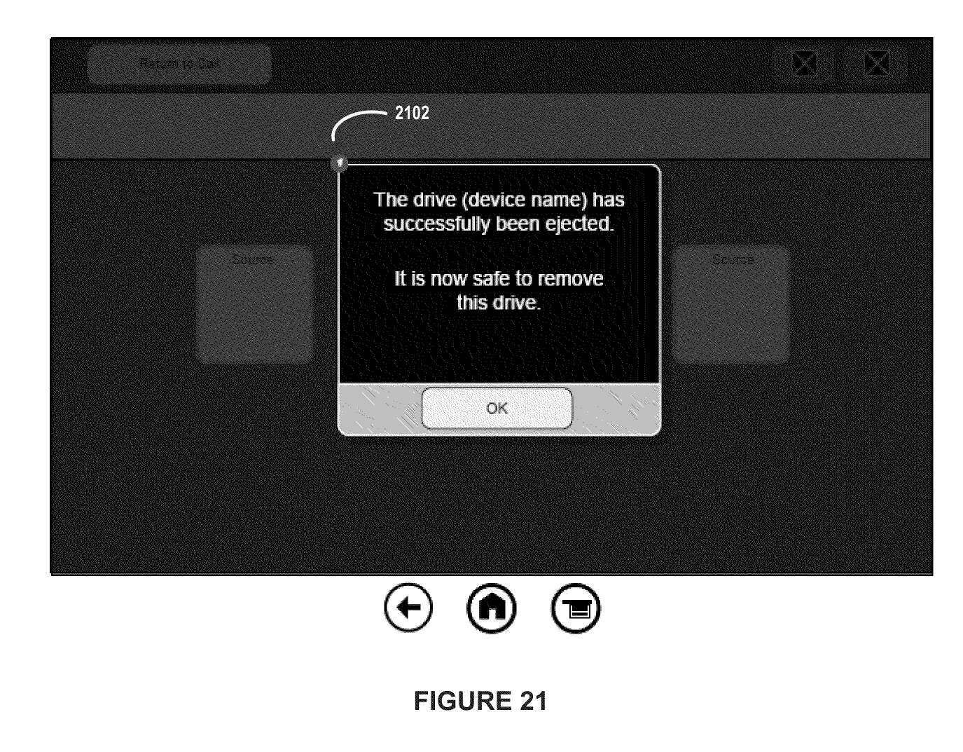

Referring to FIG. 21, a popup 2102 is shown indicating that a removable storage device has been successfully disconnected. Popup 2102 may be displayed on any of the screens incorporating an eject icon. Popup 2102 may only be displayed when a removable storage device is properly disconnected and not displayed when a removable storage device is simply removed from the user interface. When a storage device is properly removed it will no longer be displayed as a connected device on the content screen. Reestablishing a connection to the device after it has been properly removed may require the device to be removed from the user interface and reinserted in the user interface.

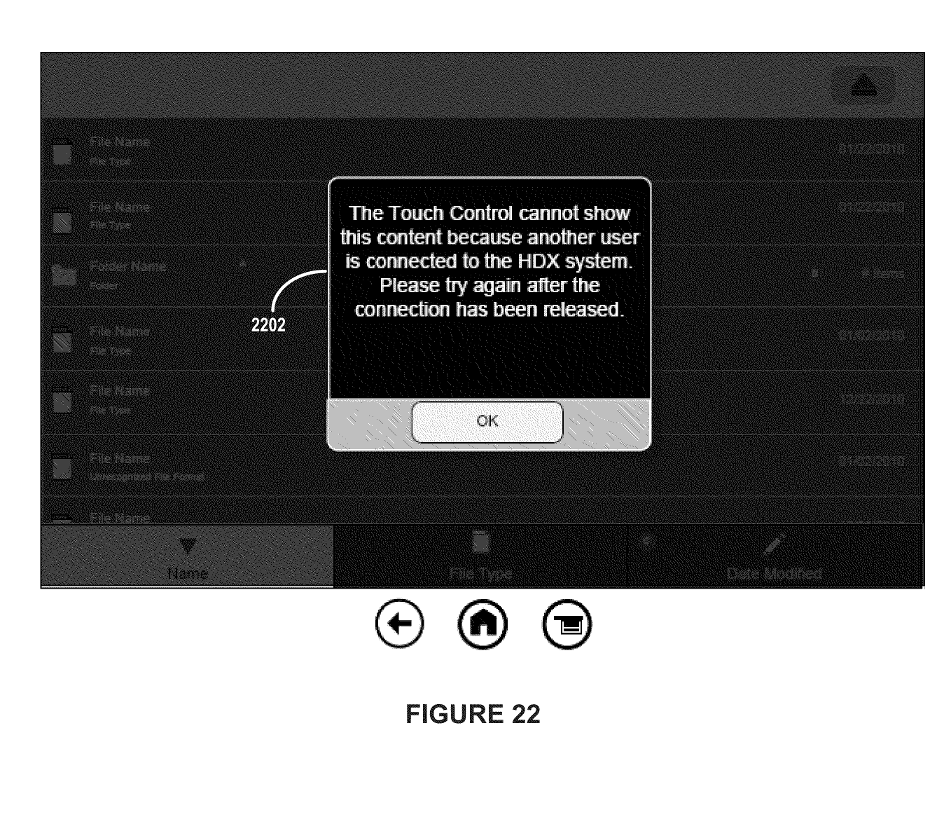

Referring to FIG. 22, a popup 2202 is shown indicating that content cannot be displayed in a videoconference because content from another source is being displayed in the videoconference. Because a videoconference may have multiple locations with one or more user interfaces at each location, in one embodiment, popup 2202 may be displayed in response to a user selecting a display icon while content from another source is already incorporated in an existing videoconference. In one embodiment, content may be incorporated from more than one source, and popup 2202 may be displayed when it is determined, for example by conferencing device 100, that a videoconference has reached a limit of the number of sources of content that can be displayed in the videoconference.

In the above detailed description, various features are occasionally grouped together in a single embodiment for the purpose of streamlining the disclosure. This method of disclosure is not to be interpreted as reflecting an intention that the claimed embodiments of the subject matter require more features than are expressly recited in each claim.

It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. A videoconference interface device comprising:
a display element;
a memory; and
a processor operatively coupled to the display element and configured to execute instructions stored in the memory to:
identify one or more software files on a portable storage device connected to the interface device, wherein the interface device is a dedicated videoconferencing peripheral;
receive a selection of one of the one or more software files by a videoconference participant;
convert the selected file to a format that can be displayed as content in a videoconference; and
transmit data representing the content to a local videoconference device for display of the content on a local videoconference display and one or more remote videoconference displays.

2. The videoconference interface device of claim 1, wherein the portable storage device is a universal serial bus (USB) flash memory device.

3. The videoconference interface device of claim 1, wherein the display element is a touch screen display.

4. The videoconference interface device of claim 1, wherein the instructions to cause the processor to identify the one or more software files on the connected portable storage device comprise instructions to cause the processor to index the one or more files.

5. The videoconference interface device of claim 4, wherein the instructions to cause the processor to index the one or more files comprise instructions to cause the processor to identify one or more files that have been previously displayed as content in a videoconference.

6. The videoconference interface device of claim 4, further comprising instructions to cause the processor to display the one or more files on the display element according to a file structure of the portable storage device.

7. The videoconference interface device of claim 1, further comprising instructions to cause the processor to receive an annotation of the content from the videoconference participant.

8. The videoconference interface device of claim 7, wherein the display element is a touch screen display and wherein the annotation is created using the touch screen display.

9. The videoconference interface device of claim 7, wherein the instructions to cause the processor to transmit data representing the content to the local videoconference device comprise instructions to cause the processor to transmit data representing the annotated content for display of the annotated content on the local videoconference display and the one or more remote videoconference displays.

10. The videoconference interface device of claim 7, further comprising instructions to cause the processor to save a file representing the annotated content on the portable storage device.

11. The videoconference interface device of claim 1, wherein the instructions to cause the processor to transmit data representing the content to the local videoconference device comprise instructions to cause the processor to transmit the data wirelessly.

12. A method, comprising:
identifying, by a videoconference interface device, one or more software files on a portable storage device connected to the interface device, wherein the interface device is a dedicated videoconferencing peripheral;
receiving, by the interface device, a selection of one of the one or more software files by a videoconference participant;
converting, by the interface device, the selected file to a format that can be displayed as content in a videoconference; and
transmitting, by the interface device, data representing the content to a local videoconference device for display of the content on at least one of a local videoconference display and one or more remote videoconference displays.

13. The method of claim 12, wherein the portable storage device is a universal serial bus (USB) flash memory device.

14. The method of claim 12, wherein the act of identifying the one or more software files on the connected portable storage device comprises compiling statistics of the one or more software files.

15. The method of claim 12, wherein contents of the portable storage device can be browsed according to a hierarchical file structure of the portable storage device.

16. The method of claim 12, further comprising receiving an annotation of the content from the videoconference participant.

17. The method of claim 16, wherein the act of transmitting data representing the content to the local videoconference device comprises transmitting data representing the annotated content for display of the annotated content on at least one of the local videoconference display and the one or more remote videoconference displays.

18. The method of claim 16, further comprising creating a file representing the annotated content on the portable storage device.

19. The method of claim 18, wherein the annotation and the content are saved in separate layers of the created file.

20. The method of claim 12, wherein the act of transmitting data representing the content to the local videoconference device comprises transmitting the data wirelessly.

21. A videoconference system comprising:
a videoconference endpoint having a display element and a content input; and
a dedicated videoconference interface device configured to execute instructions stored in a memory thereof to:
identify one or more software files on a portable storage device connected to the interface device;
receive a selection of one of the one or more software files;
convert the selected file to a format that can be displayed as content in a videoconference; and
transmit data representing the content to the content input for display of the content on the display element and one or more remote videoconference displays.

22. A method, comprising:
receiving, by a videoconference endpoint, a request to initiate a videoconference call with at least one additional videoconference endpoint from a portable user interface device;
initiating, by the videoconference endpoint, the videoconference call with the at least one additional videoconference endpoint;
receiving, by the videoconference endpoint, data representing content from the portable user interface device;
displaying, by the videoconference endpoint, the content on a display element; and
transmitting, by the videoconference endpoint, the data representing the content to the at least one additional videoconference endpoint for display.

23. The method of claim 22, wherein the portable user interface device comprises a mobile phone.

24. The method of claim 22, wherein the data representing content comprises data, representing an Internet webpage.

25. The method of claim 22, wherein the data representing content comprises data representing annotated content.
